(19) United States
(12) Patent Application Publication
(10) Pub. No.: US 2014/0267054 A1
(43) Pub. Date: Sep. 18, 2014

(54) PIVOTABLE INPUT PAD

(71) Applicants: Earl W. Moore, Cypress, TX (US); Paul N. Walker, Cypress, TX (US)

(72) Inventors: Earl W. Moore, Cypress, TX (US); Paul N. Walker, Cypress, TX (US)

(73) Assignee: Hewlett-Packard Development Company, L.P., Houston, TX (US)

(21) Appl. No.: 14/355,555

(22) PCT Filed: Jan. 25, 2012
(86) PCT No.: PCT/US2012/022616

§ 371 Date: Apr. 30, 2014

(51) Int. Cl. G06F 3/02; G06F 3/044

(52) U.S. Cl. CPC G06F 3/0227; G06F 3/044
USPC 345/168

(57) ABSTRACT

Embodiments of the present invention disclose a pivotable input pad for a portable electronic device. According to one embodiment, the electronic device includes a keyboard and a first pointing device positioned adjacent to the keyboard. Additionally, an input pad is positioned proximate to the keyboard and configured to pivot towards two opposite sides. Based on pivot movement of the input pad, a selection operation associated with the first pointing device may be executed.

### BACKGROUND

The emergence and popularity of mobile computing has made portable electronic devices, due to their compact design and light weight, a staple in today's marketplace. Moreover, providing efficient and intuitive interaction between the mobile computing system and users thereof is essential for delivering an engaging and enjoyable user-experience. Some notebook computers include a keyboard for allowing a user to manually type information into the computer system and one or more navigation means for selecting or highlighting items shown on an associated display.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1A is a three-dimensional perspective view of a portable electronic device including a pivotable input pad, while FIG. 1B is a top and enlarged section view of the pivotable input pad incorporated within the portable electronic device according to an example of the present invention.

FIGS. 2A and 2B are three-dimensional perspective views of the pivotable input pad according to an example of the present invention.

FIGS. 3A-3C are side perspective views of the pivotable input pad according to an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated no as to provide a number of additional examples of the present disclosure. In addition, the proportion and the relative scale of the elements provided in the figures are intended to illustrate the examples of the present disclosure, and should not be taken in a limiting sense.

Some notebook computing systems utilize static touchpads or trackpads formed below the keyboard and include a discrete pair of clickable selection buttons, which may represent left and right mouse click operations. However, these selection buttons consume surface area from both the touch pad and keyboard input area (i.e., z-axis space). As a result, many low-profile notebooks include haptic or clickable touchpads that also operate as a large button for providing single click functionality, thus integrating a selection button into the touchpad. For commercial low-profile notebooks utilizing both a touchpad and an additional pointing device, discrete selection buttons are still present in order to provide a selection mechanism for the pointing device.

Embodiments of the present invention disclose a pivotable input pad for a portable computing device. According to one embodiment, the computing device includes a keyboard and pointing device formed on a lower housing. The pivotable input pad is positioned on a surface of the lower housing proximate to the keyboard input area and is configured to pivot in two directions along two opposite sides (i.e., leading edge side and trailing edge side). Furthermore, the pivotable input pad is configured to replicate input or selection operations for navigation using either the pointing device or touch surface of the pivotable input pad.

Referring now in more detail to the drawings in which like numerals identify corresponding parts throughout the views, FIG. 1A is a three-dimensional perspective view of a portable electronic device, while FIG. 1B is a top and enlarged section view or the pivotable input pad incorporating within the portable electronic device according to an example of the present invention. As shown in FIG. 1A, a notebook computing system 100 is represented as the portable electronic device. In the present example, the computing system 100 includes an upper housing 102 having a display surface 104 and connected with a lower housing 106 having an input surface 108 facing the display surface 104. The input surface 108 of the lower housing 106 includes a keyboard or key input area 109 having a plurality of input keys for enabling typing input from a user. According to one example, the input surface 108 further includes a first pointing device 112 positioned within the keyboard area 109 and a second pointing device or pivotable touch input pad 110 formed proximate and adjacent to the keyboard area 109.

FIG. 1B represents an enlarged top-down view of subsection 111 relating to the input surface 108 of the lower housing 106. As shown here, the first pointing device 112 is positioned and formed in between individual keys of the keyboard (e.g., “G”, “H”, and “B” keys). The first pointing device 112 and surface of the pivotable input pad 110 represent input interfaces which permit an operating user to input spatial data to the computing system 100 for navigation on the display screen 104. According to one example, the first pointing device is an isometric joystick such as a pointing ^{stickTM} for example. The surface of the pivotable input pad 110 represents a second pointing device such as a touchpad or trackpad configured to sense and translate the motion and position of a user's fingers to a relative position on the display screen 104 (i.e. onscreen navigation). In one example, the pivotable input pad 110 is rectangular-shaped and positioned proximate to both the pointing stick 112 and key input area 109 for allowing the user convenient access to both the pointing stick 112 and the pivotable input pad 110 during operation. Accordingly, the layout and shape of the input areas (i.e., 109, 110, 112) allows the user to easily feel for all input locations without having to visually locate each individually, thereby enhancing the user experience.

FIGS. 2A and 2B are three-dimensional perspective views of the pivotable input pad according to an example of the present invention. The pivotable pad 210 includes an axle member 218 formed along its central x-axis 212. The central pivot point enables the input pad 210 to rotate downward both along the front or leading edge 222 and rear or trailing edge 224. More particularly, inward or downward pressure (−y axis) on the surface 215 of the input pad 210 is configured to activate at least one predefined button (i.e., click/selection operation) as will be explained with reference to FIG. 2B. The pivotable input pad 110 may be comprised of a plastic or glass housing. Moreover, resistive or capacitive sensors may be bonded to the bottom or underneath side of the pivotable input pad (i.e., side opposite touch surface 215) for detecting resistance or capacitance changes across the touch surface 215 in order to sense the locations of individual points of touch contact.

Turning now to the example depicted in FIG. 2B, during a click or selection operation (i.e., downward movement of the pivotable input pad 210) the touch sensors of the pivotable input pad 210 may be configured to determine the position of the user's finger 232 with respect to the touch surface 215. More particularly and in accordance with one example embodiment, downward pivot movement of the input pad 210 along the leading edge 222 while the user's finger 232 is positioned within the left quadrant 223a or right quadrant 223b, may activate left or right selection operations respectively associated with first pointing device (i.e., point stick 112 from FIG. 1B). Conversely, downward movement of the input pad 210 along the trailing edge 224 while touch is detected in the left quadrant 225a or right quadrant 225b may activate left or right selection operations respectively, associated with navigation via the second pointing device or touch surface 209. However, these operations may be reversed such that the pivot movement or downward pressure on the input pad 210 along the leading edge 222 maps to touch pad buttons/selections, while downward pressure along the trailing edge 222 maps to pointing device buttons/selections. In the example of FIG. 2B, the user's finger 232 is positioned within the lower right quadrant such that downward pressure (i.e., pivot activation) thereon would cause a right click operation associated with navigation using the touch input pad 210.

FIGS. 3A-3C are side perspective views of the pivotable input pad according to an example of the present invention. As shown in this example embodiment, the pivotable input pad 310 is positioned adjacent to the keyboard area 309. An axle element 312 is located through the x-axis centerline of the pivotable input pad 310 for enabling the input pad 310 to pivot or rotate downward in the y-direction along the leading edge 322 and opposite trailing edge 324. As such, the pivotable input pad 310 operates similar to a lever with an axle element 312 as the central pivot point. In addition, a pair of mechanical switches 327a and 327b may be coupled to a central processing unit 335 and included near an underside (i.e., side opposite touch surface side 315) of the input pad 310 for detection of depression movement of the input pad 310 along either the trailing edge 324 or leading edge 322 respectively. That is, activation of switches 327a and 327b occurs when the pivotable input pad 310 is pivoted in a first direction or second direction as shown via the directional arrows shown in FIGS. 3B and 3C.

FIG. 3B depicts depression of the pivotable input pad 310 along the trailing edge 324 of the input surface 308 associated with the lower housing. As shown, downward pressure from a user's finger 332 serves to cause the input pad 310 to move downward (i.e., first pivot direction) along the trailing edge side 324. Consequently, an edge of the input pad 310 contacts the mechanical switch 327a so as to signal to the processor that a click operation has been activated. Similarly. FIG. 3C depicts depression of the pivotable input pad 310 along the leading edge side 322 of the input surface 308 associated with the lower housing. As shown, downward pressure from a user's finger 332 serves to cause the input pad 310 to move downward (i.e., second pivot direction) along the leading edge side 322. Consequently, an edge of the input pad 310 contacts the mechanical switch 327b thereby indicating to the processor unit 335 that a click operation has been activated. As mentioned above, left and right click operations may be determined based on the relative quadrant location of the user's finger at the time of button/click activation (i.e., touch surface position along the z-axis).

Example embodiments of the present invention disclose a pivotable input pad for a portable computing device. Moreover, many advantages are afforded by inclusion of the pivotable input pad according to examples of the present invention. For instance, the pivotable input pad eliminates the need for discrete selection buttons associated with the integrated point device. In addition, the example embodiments disclosed herein have an ergonomic benefit by allowing an operating user to locate edges of the pivotable input pad through physical touch alone rather than visual identification.

Furthermore, while the invention has been described with respect to exemplary embodiments, one skilled in the art will recognize that numerous modifications are possible. For example, although exemplary embodiments depict a notebook computer as the portable electronic device, the invention is not limited thereto. For example, the portable electronic device may be a netbook, a tablet personal computer, a cell phone, or any other electronic device having multiple pointing devices.

Furthermore, the first pointing device may be formed at any position proximate to the keyboard area and pivotable input pad. In addition, the pivotable input pad may be formed of any size and shape conducive to easy operation and location by an operating user. Thus, although the invention has been described with respect to exemplary embodiments, it will be appreciated that the invention is intended to cover all modifications and equivalents within the scope of the following claims.

What is claimed is:

1. A computing system having a display and comprising:
a keyboard;
a first pointing device positioned adjacent to the keyboard; and
an input pad positioned proximate to the keyboard and configured to pivot towards two opposite sides,
wherein at least one selection operation associated with the first pointing device is executed based on pivot movement of the input pad.

2. The computing system of claim 1, further comprising:
a first switch element positioned near a leading edge side of the input pad for detecting movement of the input pad in the first pivot direction; and
a second switch element positioned near a trailing edge side of the input pad for detecting movement of the input pad in a second pivot direction.

3. The computing system of claim 2, wherein the input pad further includes a touch capacitive surface for detecting touch input from an operating user.

4. The computing system of claim 3, wherein pivoting movement of the input pad in the first direction effectuates a selection operation associated with the first pointing device.

5. The computing system of claim 3, wherein pivoting movement of the input pad in the second direction effectuates a selection operation associated with the touch surface of the input pad.

6. The computing system of claim 3, wherein activation of the first switch while a touch is detected within a first quadrant of the input pad causes a left click operation associated with the first pointing device, and activation of the first switch while a touch is detected within a second quadrant of the input pad causes a right click operation associated with the first pointing device.

7. The computing system of claim 6, wherein activation of the second switch while a touch is detected within a third quadrant of the input pad causes a left click operation associated with the touch surface, and activation of the second switch while a touch is detected within a fourth quadrant of the input pad causes a right click operation associated with the touch surface.

8. The computing system of claim 1, further comprising:
an axle element formed within a central area of the input pad for enabling pivotable movement of the input pad in the first direction and the second direction.

9. A pivotable input pad for a notebook computer having an integrated keyboard and a first pointing device formed therein, the input pad comprising:
a touch capacitive surface for detecting touch input from an operating user; and
an axle element formed within a central area of the input pad for enabling pivotable movement of the input pad in a first pivot direction and a second pivot direction,
wherein the input pad is positioned adjacent to the keyboard and configured to pivot toward a leading edge side and an opposite trailing edge side;
wherein at least one selection operation associated with the first pointing device is executed based on pivot movement of the input pad.

10. The input pad of claim 9, further comprising:
a first switch element positioned near the leading edge side of the input pad for detecting movement of the input pad in the first pivot direction; and
a second switch element positioned near the trailing edge side of the input pad for detecting movement of the input pad in the second pivot direction.

11. The input pad of claim 9, wherein pivot movement in the first pivot direction serves to activate at least one button click operation associated with the first pointing device, and
wherein pivot movement in the second pivot direction serves to activate at least one button click operation associated with the touch surface of the input pad.

12. The input pad of claim 9, wherein activation of the first switch while a touch is detected within a first quadrant of the input pad causes a left click operation associated with the first pointing device, and activation of the first switch while a touch is detected within a second quadrant of the input pad causes a right click operation associated with the first pointing device.

13. The input pad of claim 12, wherein activation of the second switch while a touch is detected within a third quadrant of the input pad causes a left click operation associated with the touch surface of the input pad, and activation of the second switch while a touch is detected within a fourth quadrant of the input pad causes a right click operation associated with the touch surface of the input pad.

14. A portable computing device having and display and comprising:
a keyboard;
a first pointing device positioned with the keyboard;
an input pad positioned proximate to the keyboard and configured to pivot toward a leading edge side and a trailing edge side;
a first switch element positioned near the leading edge side of the input pad and configured to detect pivot movement of the input pad in a first pivot direction; and
a second switch element positioned near a trailing edge side of the input pad and configured to detect pivot movement of the input pad in a second pivot direction,
wherein input operations associated with the first pointing stick are executed based on pivot movement of the input pad.

15. The computing device of claim 14, wherein activation of the first switch while a touch is detected within a first quadrant of the input pad causes a left click operation associated with the first pointing device, and activation of the first switch while a touch is detected within a second quadrant of the input pad causes a right click operation associated with the first pointing device, and
wherein activation of the second switch while a touch is detected within a third quadrant of the input pad causes a left click operation associated with the touch surface of the input pad, and activation of the second switch while a touch is detected within a fourth quadrant of the input pad causes a right click operation associated with the touch surface of the input pad.
